(19) United States
(12) Patent Application Publication
(10) Pub. No.: US 2015/0067717 A1
(43) Pub. Date: Mar. 5, 2015

(54) VIDEO PLAYER CENSOR SETTINGS

(71) Applicant: Verizon Patent and Licensing Inc., Basking Ridge, NJ (US)

(72) Inventor: Michael R. Oliver, Wayne, NJ (US)

(73) Assignee: Verizon Patent and Licensing Inc., Basking Ridge, NJ (US)

(21) Appl. No.: 14/010,763

(22) Filed: Aug. 27, 2013

(51) Int. Cl. H04N 21/454; H04N 21/488; H04N 21/475

(52) U.S. Cl. CPC H04N 21/4542; H04N 21/4755; H04N 21/4882
USPC 725/28

(57) ABSTRACT

A method includes receiving, at a user device, video content, and providing, on an interface of the user device, a video censor toggle that is configured to provide video censoring components based on an input received from a user. The video censoring components are to substantially obscure the video content in a manner that a person without previous context of the video content will be unable to determine activities depicted in the video content. The method includes receiving a selection of the video censor toggle from the user at a particular time. The method also includes substantially obscuring the objectionable video content using the video censoring components based on the selection at the video censor toggle.

### BACKGROUND

Video service providers provide video content to users that may be received and displayed at multiple different types of devices. In some instances, the video content may be provided to the devices within a home network, such as set top boxes, personal computers, etc. In other instances, the video content provider may provide video content to mobile devices via mobile networks (e.g., long term evolution (LTE) networks, wireless networks) in public spaces.

Video content delivered to the user device in a public space may be susceptible to unwanted viewing by persons in a vicinity of the user of the mobile device that receives the video content. The video content may include scenes or sequences that have varying levels of objectionable content, which the user may not wish to display or have other people view. For example, some scenes may include graphic violence, nudity, etc.

### BRIEF DESCRIPTION OF THE DRAWINGS

FIG. 1 is an exemplary network in which systems and/or methods described herein may be implemented;

FIGS. 2A and 2B, respectively, are exemplary user interfaces illustrating video player censor settings according to implementations described herein;

FIG. 3 is a diagram of an exemplary display device in which methods and systems described herein may be implemented;

FIG. 4 is a block diagram of exemplary components of a device that may correspond to one of the devices of FIG. 1;

FIG. 5 is a functional block diagram of a video player censor client device according to an implementation described herein;

FIG. 6 is an exemplary user interface including video player censor elements according to an implementation described herein;

FIG. 7 is a functional block diagram of the video censor server of FIG. 1;

FIG. 8 is a flow chart of an exemplary process for providing video player censor according to an implementation described herein; and

FIG. 9 is a flow chart of another exemplary process for providing video player censor according to an implementation described herein.

### DETAILED DESCRIPTION OF PREFERRED EMBODIMENTS

The following detailed description refers to the accompanying drawings. The same reference numbers in different drawings may identify the same or similar elements. Also, the following detailed description is exemplary and explanatory only and is not restrictive of the invention, as claimed.

Systems and/or methods described herein may provide video player censor for a user device that receives video content. The video content may include acceptable content, which a user of the user device may approve of others viewing and objectionable content, which the user may not approve of others viewing. The objectionable content may include content that is not fit for the particular place, such as nudity, graphic violence, etc. The systems may provide a capability for the user device that receives video content to substantially obscure the video content based on the detection of objectionable content.

The system may include video censor controls that allow a user to provide instructions to the user device to enter a “censor mode” in which the user device substantially obscures (e.g., partially obscures or fully blocks) a substantial portion of the video content when objectionable content is detected. In one embodiment, the systems may provide video censoring components, including graphical elements and/or video censor graphical effects that may be used to obscure the objectionable content. For example, the system may use the video censor graphical effects to pixelate, obfuscate, block, blur or otherwise reduce the distinguishability of the objectionable content. The video censoring components may be used to protect the privacy of the video content and prevent unwanted parties from viewing content on the user device (e.g., when the user is in a public place or other persons are in a vicinity of the user). The video content that is not obscured may be regarded as in a “public mode”.

Consistent with embodiments described, the system herein may include a video censor toggle on the user device or an interface on (or associated with) the user device. The video censor toggle may allow the user to manually provide input to switch to or from (i.e., toggle) the censor mode (from or to the public mode) with a substantially minimal predetermined input. In some implementations, this toggle to a particular mode may last indefinitely until removed by the user. The video censoring components may block or obscure scenes or sequences of a video program in a manner that allows a user to monitor for changes in the scene. For example, the video censoring components may blur out the video content displayed on the screen of the user device so that someone without previous context or an audio stream would be unable to ascertain what is happening on the screen, while the user may be able to detect scene transitions from objectionable content to acceptable content.

Consistent with embodiments described herein, the systems and methods may provide different settings that obscure the objectionable video content along a continuum or based on a set of discrete settings, such as a low, medium and high. The obscuring or blocking of the content may take up the entire screen or the majority of the screen depending upon the setting. If the user chooses a high setting from the discrete settings, the screen may be totally blocked (e.g., blacked out) for a substantial majority of the screen with a sufficient but limited portion of the screen unblocked or partially obscured (e.g., a square in one of the corners) so the user may determine that the scene has changed and provide input to exit the censor mode.

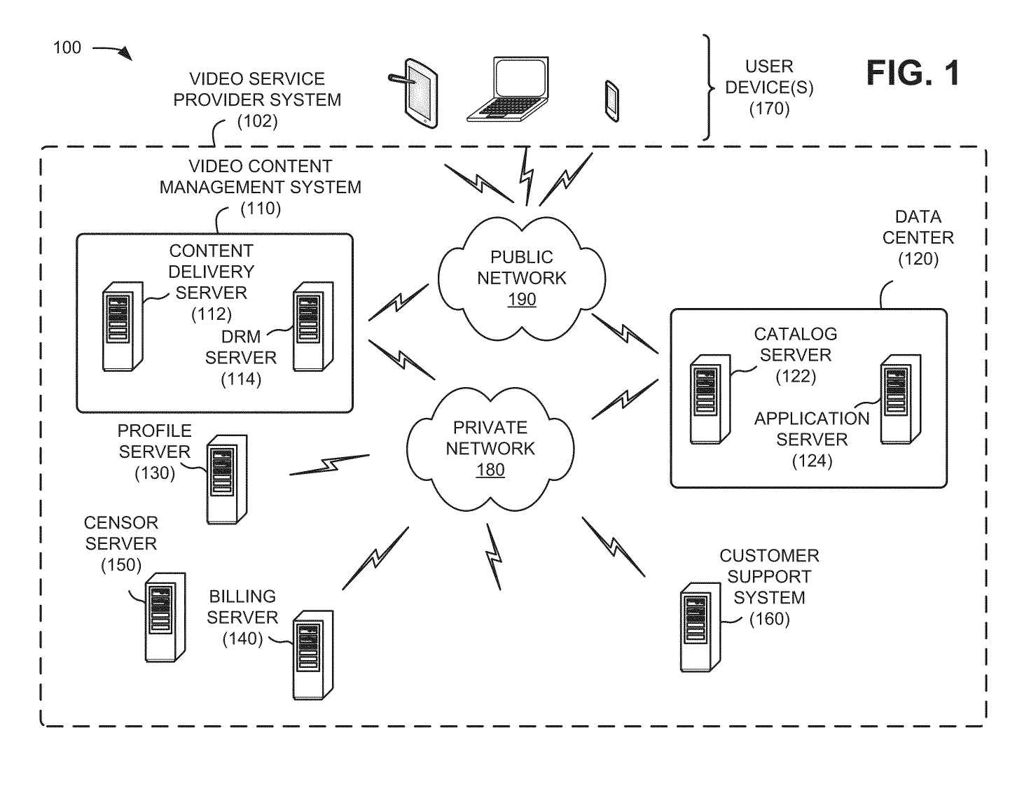

FIG. 1 is an exemplary network 100 in which systems and/or methods described herein may be implemented. As illustrated, network 100 may include a video service provider system 102 and user devices 170, which may receive a video service from video service provider system 102. Video service provider system 102 may include video content management system (VCMS) 110, a data center 120, a profile server 130, a billing server 140, a video censor server 150, a customer support system 160, user devices 170, a private network 180, and a public network 190. The particular arrangement and number of components of network 100 shown in FIG. 1 are illustrated for simplicity. In practice there may be more VCMSs 110, data centers 120, profile servers 130, billing servers 140, video censor servers 150, customer support systems 160, user devices 170, and/or networks 180/190. Components of network 100 may be connected via wired and/or wireless links.

User devices 170 may enable a user to receive video content (i.e., an online video session, cable TV service) from video service provider system 102. User devices 170 may include, for example, set top box, a gaming console, a personal communications system (PCS) terminal (e.g., a smartphone that may combine a cellular radiotelephone with data processing and data communications capabilities), a tablet computer, a personal computer, a laptop computer, an Internet television, or other types of computation or communication devices.

In implementations described herein, user device 170 may include machine readable instructions that implement video censor controls that allow a user to control the application of video censoring components to video content to block or obscure objectionable video content as described herein.

Video service provider system 102 may be part of a core network that provides online video service. Video service provider system 102 may be affiliated with a service provider entity (e.g., a commercial video service provider). Video service provider system 102 may provide video content that includes video programs which have a mix of sequences of acceptable content and objectionable content to user devices 170. For example, the objectionable content may include graphic violence, nudity or age inappropriate content.

VCMS 110 may aggregate content, process content, and distribute content. In one implementation, VCMS 110 may include a content delivery server 112 and a digital rights management (DRM) server 114. VCMS 110 may aggregate content and transcode content into a digital format suitable for consumption on particular user devices 170. For example, VCMS 110 may include a transcoding device to convert an audio, video, multimedia or graphic file from one format to another (e.g., from one bit rate to another bit rate, from one resolution to another, from one standard to another, from one file size to another, etc.). VCMS 110 may also encrypt data and communicate with user devices 170 through DRM server 114 to enforce digital rights.

Content delivery server 112 may deliver digital content from a backend server to user devices 170. In one implementation, content delivery server 112 may include a streaming server that provides streaming data packets (e.g., via a streaming uniform resource locator (URL)) to user devices 170 (e.g., via public network 190). In one implementation, a streaming URL may be session-based, such that each URL can be used only once for one user device 170 for security purposes.

DRM server 114 may issue, validate, and/or enforce DRM licenses to a mobile client, such as an application running on one of user devices 170. In implementations described herein, DRM server 114 may communicate with user device 170 to validate an authorization token in issuing a license for an application residing on user device 170.

Data center 120 may manage the authorization, selection, and/or purchase of multimedia content by a user of user device 170 (i.e., based on input associated with the user received from user device 170). As shown in FIG. 1, data center 120 may include a catalog server 122 and an application server 124. In one implementation, user devices 170 may access data center 120 via public network 190.

Catalog server 122 may provide a catalog of content for users (e.g., of user devices 170) to order/consume (e.g., buy, rent, or subscribe). In one implementation, catalog server 122 may collect and/or present listings of content available to user devices 170. For example, catalog server 122 may receive digital content metadata, such as lists or categories of content, from VCMS 110. Catalog server 122 may use the content metadata to provide currently available content options to user devices 170. Catalog server 122 may provide the content metadata to user device 170 directly or may communicate with user device 170 via application server 124.

Application server 124 may provide a backend support system for applications residing on user devices 170. For example, application server 124 may permit user device 170 to download an application that enables a user to control video player censor or play downloaded or streaming content. Application server 124 may provide digital content in association with VCMS 110. In one implementation, the interactions between application server 124 and user device 170 may be performed using hypertext transfer protocol (HTTP) or secure HTTP (HTTPS) via public network 190. In one implementation, all HTTP transport may be over secure sockets layer (SSL) or transport layer security (TLS). Application server 124 may provide authentication of user devices 170 and secure delivery of credit card information.

Profile server 130 may store user profile information for users (e.g., users of user devices 170). The user profile information may include various information regarding a user, such as login information (e.g., a user identifier and a password), billing information, address information, types of services or lists of content that the user has subscribed, purchased, or rented, a user device identifier (e.g., a media player identifier, a mobile device identifier, an application identifier) for user device 170, or the like. Profile server 130 may also store video censor preferences for the user that may control the application of video censoring components to video content on user devices associated with the user.

Billing server 140 may manage charging users for services provided via video service provider system 102. Billing server 140 may include, for example, a payment processing component, a billing component, and/or a settlement component. In some implementations, billing services may be performed by servers external to video service provider system 102 (e.g., billing servers for a partner entity).

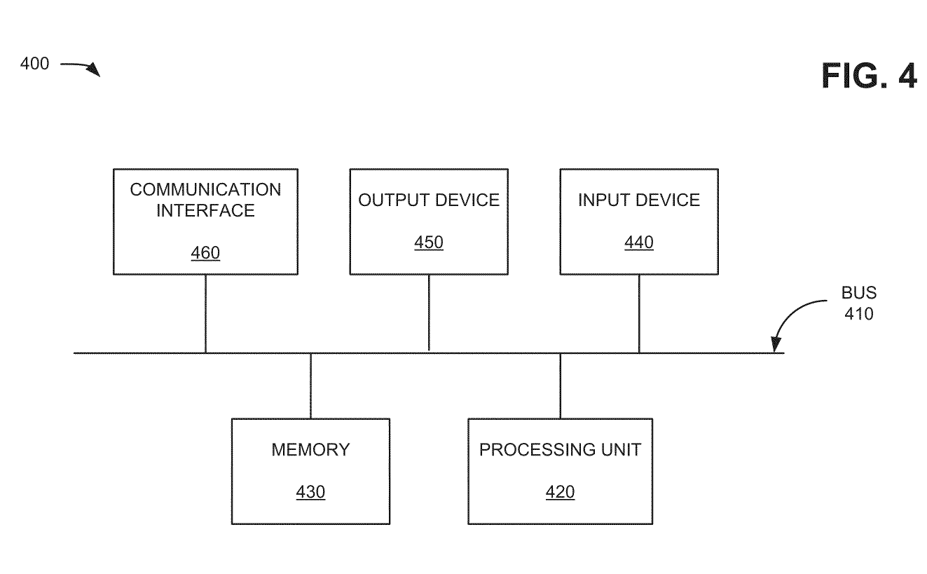

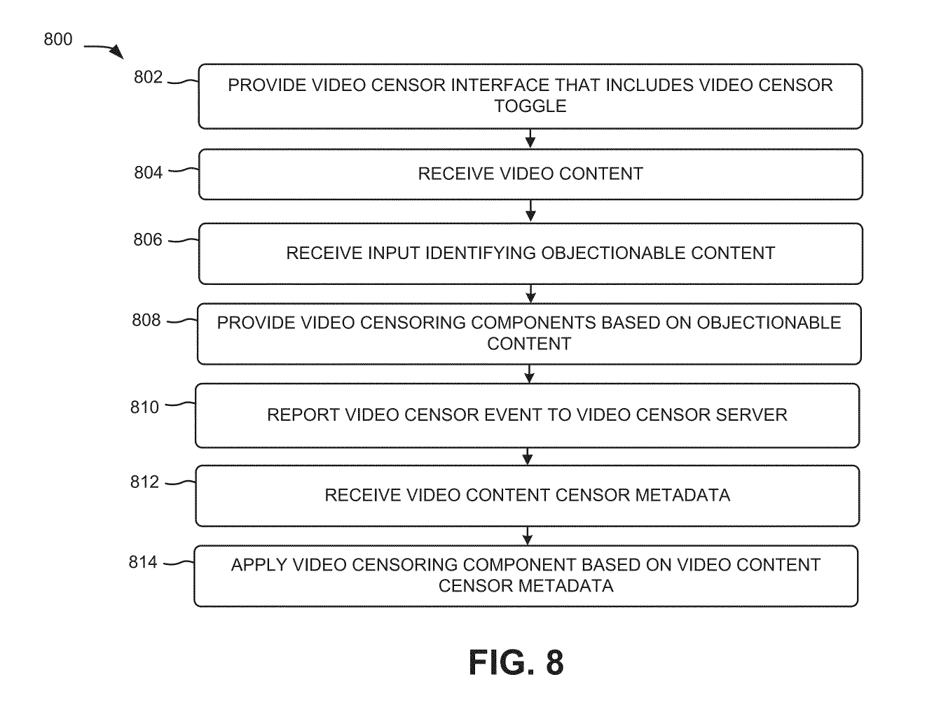

Video censor server 150 may provide support for video player censor controls on user devices 170, such as described hereinbelow with respect to FIG. 8. For example, video censor server 150 may enable video censor controls that manage the application of video censoring components in conjunction with user device 170, such as described with respect to FIGS. 4, 5, 6, and 7. Video censoring components may include video censor graphical elements and video censor graphical effects that obscure the video content. Video censor server 150 may also provide video player censor applications and define video censor graphical elements and video censor graphical effects in association with application server 124. Video censor server 150 may use the user profile information from profile server 130 to provide video censoring components based on the user's preferences.

Customer support system 160 may solicit and/or receive user feedback, questions, or credit/billing-related requests.

Private network 180 may include, for example, one or more private IP networks that use a private IP address space. Private network 180 may include a local area network (LAN), an intranet, a private wide area network (WAN), etc. In one implementation, private network 180 may implement one or more Virtual Private Networks (VPNs) for providing communication between, for example, any of VCMS 110, data center 120, profile server 130, billing server 140, video censor server 150, and/or customer support system 160. Private network 180 may be protected/separated from other networks, such as public network 190, by a firewall. Although shown as a single element in FIG. 1, private network 180 may include a number of separate networks.

Public network 190 may include a LAN, a WAN, such as a cellular network, a satellite network, a fiber optic network, a private WAN, or a combination of the Internet and a private WAN, etc., that is used to transport data. Although shown as a single element in FIG. 1, public network 190 may include a number of separate networks that function to provide services to user devices 170.

In implementations described herein, video player censor controls may be provided to allow a user to provide input to apply video censoring components to partially obscure or totally block objectionable content. The video player censor controls may be supported by video censor server 150 and other devices in network 100. The video player censor controls may include a video censor toggle on user device 170.

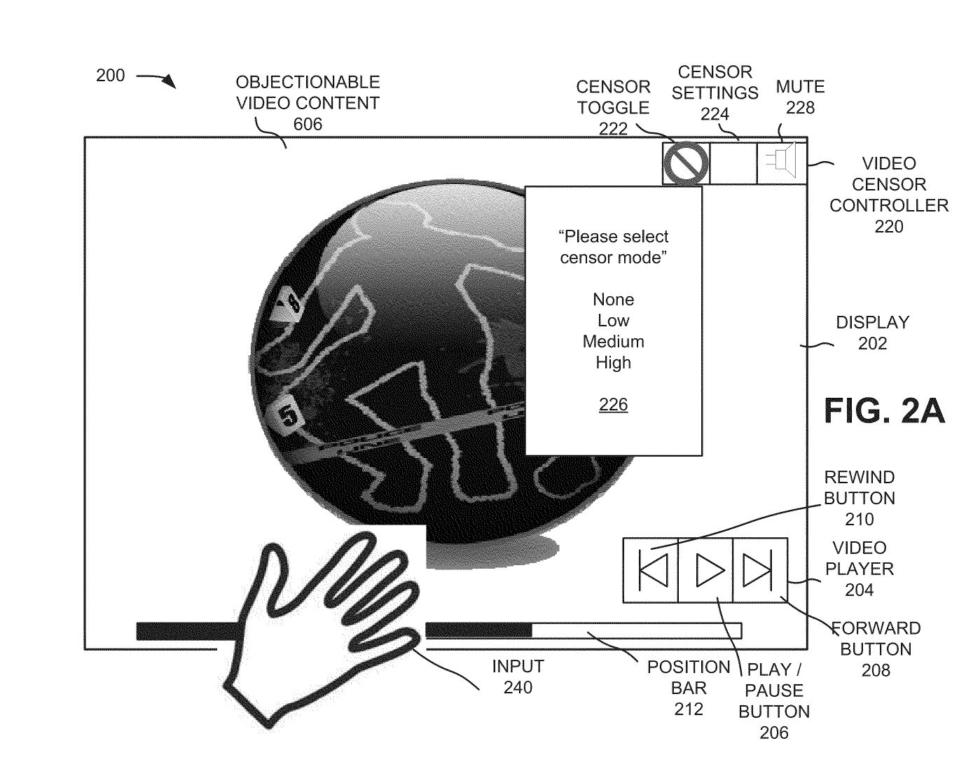

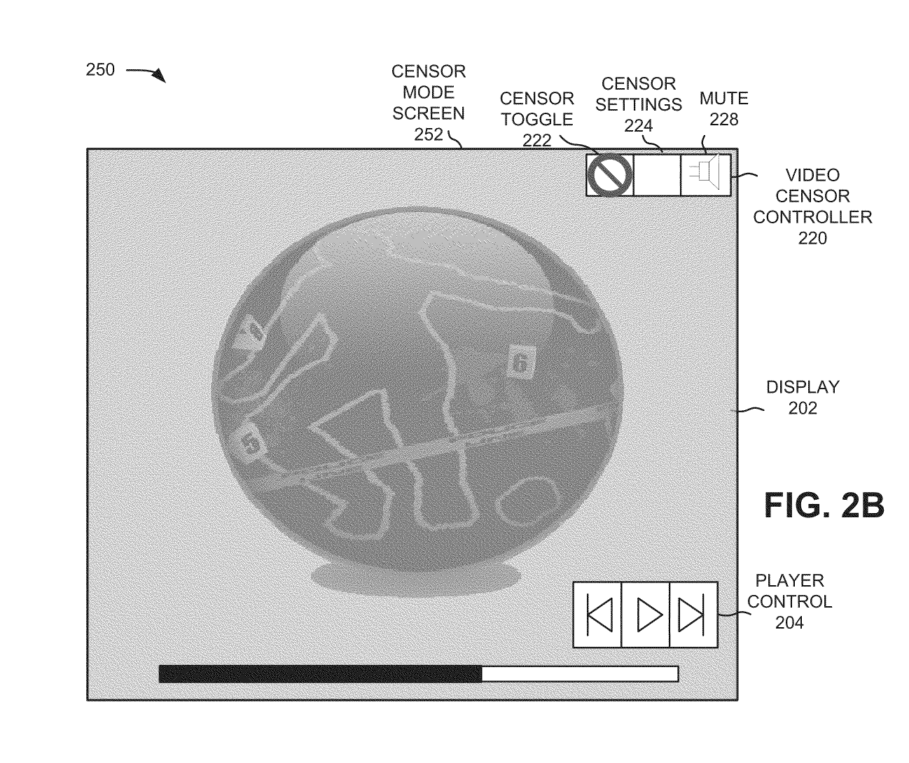

FIGS. 2A and 2B are exemplary user interfaces, 200 and 250 respectively, illustrating video player censor settings according to an implementation described herein. As shown in FIGS. 2A and 2B, the user interfaces may include a display 202, a video player 204, and a video censor controller 220. Video player 204 may include a play button 206, a (fast) forward button 208, a rewind button 210 and an (associated) video position bar 212. Video censor controller 220 may include a video censor toggle 222, video censor settings 224, censor message 226, and mute button 228. Although user interfaces 200 and 250 are shown with particular components arranged in a particular configuration, it should be understood that more, fewer or differently arranged components may be used in other implementations to provide video player censor. Further, although the video censor is described with respect to network 100, in some implementations, video censor may be implemented as a stand-alone application on user device 170.

As shown in FIG. 2A, video player 204 may provide a capability for the user to input instructions to control the playback of video content. The video content may be received from video service provider system 102 and processed and played. Alternatively, the video content may be stored on user device 170.

Video player 204 may play video content or pause playing of video content on user device 170 based on input 240 received from a user (e.g., a finger on a touch screen of user device 170) to play/pause button 206. Video player 204 may also fast forward (fast forward button 208) or rewind (rewind button 210) the video content based on input 240 received from the user.

The video content may include sequences of potentially objectionable content and/or sequences of acceptable content. For example, the video content may be an R (Restricted) rated movie that includes nudity and/or graphic violence. The potentially objectionable video content may be determined to be objectionable based on manual assessment by the user of user device 170. Alternatively, the potentially objectionable video content may be determined to be objectionable based on information provided by video censor server 150, including aggregated assessments of objectionable video content by other users of user devices 170 that are fed back to video censor server 150.

Video censor controller 220 may allow the user to control the application of video censoring components to provide censor and obscure objectionable video content. While watching the video content in a public place, the user may determine that objectionable content is not fit to be displayed in a particular setting (e.g., based on being public, the presence of minors, etc.). The video censoring components may substantially obscure the video content in a manner that a person without previous context of the video content will be unable to determine activities depicted in the video content. In one implementation, the video censoring components may blur out the screen so that someone without previous context or an audio stream may be unable to ascertain what is happening in the video content. The video censoring components may be applied indefinitely until removed by the user.

Video censor toggle 222 may provide a signal for user device 170 to apply the video censoring components or to remove the video censoring components. Video censor toggle 222 may be implemented as a button on a touchscreen as shown in FIG. 2A. Alternatively, video censor toggle may be implemented as a dedicated button on the player itself, as a combination of key strokes, or by a particular motion detectable by motion detectors associated with user device 170.

Video player censor setting 224 may provide a link to a range of options for implementing video censor on user device 170 based on a user preference for application of video censoring components to the objectionable video content. The video content may include different types of objectionable content. For example, the video content may include violence, nudity, etc. Video player censor setting 224 may allow the user to select from a menu of options which may be displayed in censor message 226. For example, censor message 226 may state “please select censor mode” and provide a menu of different options for censor mode on user device 170. These options may include a set of discrete values for video censor such as none, indicating no video censoring components to be added, low, medium or high, indicating an increasing range of censor and obscuring the video content by applying video censoring components that increasingly obscure the objectionable video content. In another embodiment, the settings for video censor may increase along a continuum that increasingly obscures the objectionable video content.

According to an embodiment, video censor settings may include additional settings that determine particular types of objectionable content that is to be obscured. For example, video censor settings may identify the objectionable video content as nude content or graphic violence content. Video censor settings may also identify a particular type of video censor protecting component to be automatically applied to particular types of objectionable content. For example, the video censor settings may include an option to automatically have nudity totally blocked while only partially obscuring graphical violence or allowing the user to manually block the graphical violence.

As shown in FIG. 2B, a censor mode screen 252 may include the video censor protecting component applied as a blurring effect that covers all or a substantial part of the video content (in this instance objectionable content). The underlying objectionable video content may be distinguishable to the user based on colors in a particular scene and other recognizable shared aspects of the obscured objectionable video content with the unblocked objectionable video content (i.e., the user may be able to identify that there is a person in the obscured objectionable video content but may be unable to identify what the person is doing).

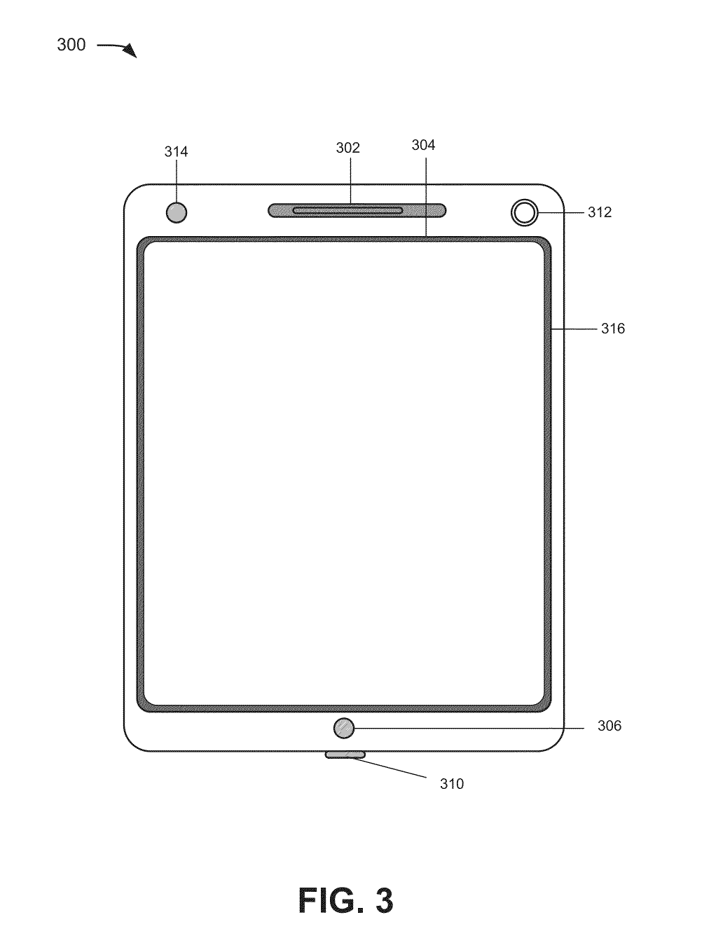

FIG. 3 is a diagram of an exemplary device 300 in which methods and systems described herein may be implemented. Although illustrated as a tablet or touch screen device, device 300 may include any of the following devices: an electronic notepad, a tablet computer, a laptop, and/or a personal computer; a set top box; a gaming device or console; or another type of computational or communication device.

In this implementation, device 300 may take the form of a tablet computer. As shown in FIG. 3, device 300 may include a speaker 302, a touchscreen display 304, control button 306, a microphone 310, sensors 312, a front camera 314, and a housing 316. Speaker 302 may provide audible information to a user of device 300. Although device 300 is shown with particular components and a particular configuration, device 300 may include fewer, more or different components, such as additional sensors, input devices, and may include associated devices (e.g., a stylus) etc.

Display 304 may provide visual information to the user, such as an electronic program guide, video censor controls, video images, or pictures. In addition, display 304 may include a touchscreen for providing input to device 300. Display 304 may provide hardware/software to detect the coordinates of an area that is touched by a user. For example, display 304 may include a display panel, such as a liquid crystal display (LCD), organic light-emitting diode (OLED) display, and/or another type of display that is capable of providing images to a viewer. Display 304 may include a transparent panel/surface for locating the position of a finger or an object (e.g., stylus) when the finger/object is touching or is close to display 304.

Control button 306 may permit the user to interact with device 300 to cause device 300 to perform one or more operations, such as place or receive a telephone call, input data to device 300, manipulate user interface elements, etc. In some implementations, control buttons 306 may include a telephone keypad (not shown) or an alphanumeric keyboard. Microphone 310 may receive audible information from the user.

According to an implementation, sensors 312 may collect and provide, to device 300, information (e.g., acoustic, infrared, etc.) that is used to aid the user in applying video player censor controls based on providing information related to the presence of other individuals in a proximity of the user (e.g., motion detectors for peripheral motion), capturing images or in providing other types of information (e.g., a distance between a user and device 300, a position and/or proximity of additional persons with regard to the device). Front camera 314 may enable a user to view, capture and store images (e.g., pictures, video clips) of a subject in front of device 300. Housing 316 may provide a casing for components of device 300 and may protect the components from outside elements.

FIG. 4 is a diagram of exemplary components of a device 400. Each of VCMS 110, content delivery server 112, DRM server 114, data center 120, catalog server 122, application server 124, profile server 130, billing server 140, video censor server 150, customer support system 160, or user device 170 may include one or more devices 400. As shown in FIG. 4, device 400 may include a bus 410, a processing unit 420, a memory 430, an input device 440, an output device 450, and a communication interface 460.

Bus 410 may permit communication among the components of device 400. Processing unit 420 may include one or more processors or microprocessors that interpret and execute instructions. In other implementations, processing unit 420 may be implemented as or include one or more application specific integrated circuits (ASICs), field programmable gate arrays (FPGAs), or the like.

Memory 430 may include a random access memory (RAM) or another type of dynamic storage device that stores information and instructions for execution by processing unit 420, a read only memory (ROM) or another type of static storage device that stores static information and instructions for the processing unit 420, and/or some other type of magnetic or optical recording medium and its corresponding drive for storing information and/or instructions.

Input device 440 may include a device that permits an operator to input information to device 400, such as a keyboard, a keypad, a mouse, a pen, a microphone, one or more biometric mechanisms, and the like. Output device 450 may include a device that outputs information to the operator, such as a display, a speaker, etc.

Communication interface 460 may include a transceiver that enables device 400 to communicate with other devices and/or systems. For example, communication interface 460 may include mechanisms for communicating with other devices, such as other devices of network 100.

As described herein, device 400 may perform certain operations in response to processing unit 420 executing machine-readable instructions contained in a computer-readable medium, such as memory 430. A computer-readable medium may include a non-transitory memory device. A memory device may include space within a single physical memory device or spread across multiple physical memory devices. The machine-readable instructions may be read into memory 430 from another computer-readable medium or from another device via communication interface 460. The machine-readable instructions contained in memory 430 may cause processing unit 420 to perform processes described herein. Alternatively, hardwired circuitry may be used in place of or in combination with machine-readable instructions to implement processes described herein. Thus, implementations described herein are not limited to any specific combination of hardware circuitry and machine-readable instructions.

Although FIG. 4 shows exemplary components of device 400, in other implementations, device 400 may include fewer components, different components, differently arranged components, or additional components than depicted in FIG. 4. As an example, in some implementations, input device 440 and/or output device 450 may not be implemented by device 400. In these situations, device 400 may be a “headless” device that does not explicitly include an input or an output device. Alternatively, or additionally, one or more components of device 400 may perform one or more other tasks described as being performed by one or more other components of device 400.

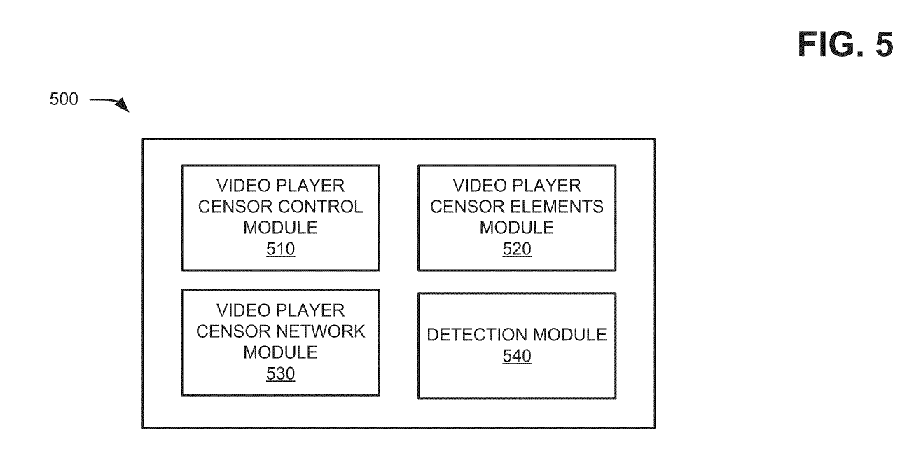

FIG. 5 illustrates an exemplary functional block diagram of video censor client device 500. Device 500 may comprise software, hardware, or a combination of hardware and software used to provide video censor on user device, such as user device 170 described above. As shown, video censor client device 500 may include a video player censor control module 510, a video player censor effects module 520, a video player censor network module 530 and a detection module 540. The configuration of components of video censor client device 500 illustrated in FIG. 5 is for illustrative purposes only. Other configurations may be implemented. Therefore, video censor client device 500 may include additional, fewer and/or different components than those depicted in FIG. 5.

Video player censor control module 510 may provide interface elements and controls to select video player censor settings for applying video censoring components to objectionable content. For example, video player censor control module 510 may render a graphical representation of video censor controller 220 in an interface of user device 170. Video player censor control module 510 may receive instructions based on user interaction with the graphical representation of video censor controller 220. For example, video player censor control module 510 may allow the user to toggle from a censor mode, in which video censoring components are applied to objectionable content, to a public mode (i.e., an uncensored mode). Video player censor control module 510 may allow the user to define or implement a range of modes (including intermediate modes) for the applying the video censoring components in the private mode.

Video player censor control module 510 may implement the video censor toggle via physical or touchscreen input keys associated with user device. Alternatively, the video censor toggle may be implemented via motion sensor, speech recognition or other mechanisms that do not require physical contact with the user device.

According to one embodiment, video player censor control module 510 may allow the user to select from a range of age groups settings, such as older adult, young adult, family setting, children under age 13, etc., to automatically apply video censoring components to different types of objectionable content.

Video player censor effects module 520 may implement the application of the selected video censoring components to objectionable content. Video player censor effects module 520 may provide different effects to obscure the objectionable content (e.g., video censor effects may blur, fade, shade, obfuscate, veil, etc., the objectionable content) in different combinations based on different types of objectionable content and different types of environments in which the user operates user device 170.

According to one implementation, video player censor effects module 520 may also implement audio censor effects on accompanying audio streams (e.g., the volume may be reduced or filtered to background noise). Video player censor effects module 520 may synchronize the application of the video censoring components to the objectionable content with correlated obscuring effects on the close captioning and/or audio.

According to another implementation, video player censor effects module 520 may provide a video censor effect of (temporarily) lowering a level of video censoring components (i.e., reducing the censor blocking) at scene changes. This may allow the user to momentarily assess whether to completely remove the video censoring components.

Video player censor network module 530 may communicate with video player censor server 150 to send and receive video censor metadata that may be used in applying video censoring components to objectionable video content. Video censor metadata may include information identifying a time in a video program at which each instance of objectionable content is identified, a duration of the objectionable content, a particular type of objectionable content, and a demographic of the persons who identify particular objectionable content. The video censor metadata may be collected from other users that identify objectionable video content in video programs selected by the user of user device 170. Each instance in which the user manually identifies objectionable video content may be sent to video player censor server 150.

According to one embodiment, video player censor network module 530 in conjunction with video player censor control module 510 may provide an estimate of a percentage of particular types of objectionable content in a particular video program. For example, video player censor control module 510 may receive an estimate of a percentage of particular types of objectionable content in a video program selected by the user. The user may then choose whether to view the video program based on a percentage of objectionable content in the video program (e.g., if there is more than ten percent of objectionable content in a movie, the user may choose not to watch that movie in a venue where video censor would be required).

Detection module 540 may detect external conditions to user device 170 that may indicate the presence of additional persons and may be used as a factor in the implementation of video censor. For example, detection module 540 may detect a location of user device 170 or the presence or proximity of other persons (i.e., different people around the user device and user) to the user. Video player censor control module 510 may provide video censoring components based on the detected presence or proximity of the other person (e.g., video player censor control module 510 may provide or increase the level of the video censoring components based on a closer proximity of the other person to user device 170). Video player censor control module 510 in conjunction with detection module 540 may increase a level of video censor in particular physical settings or if other persons are detected within a particular proximity of the user device 170. Detection module 540 may detect a type of network that user device 170 is connected to and the presence of other networks. Video player censor control module 510 may select a highest level of censor when the user receives video content via a public network.

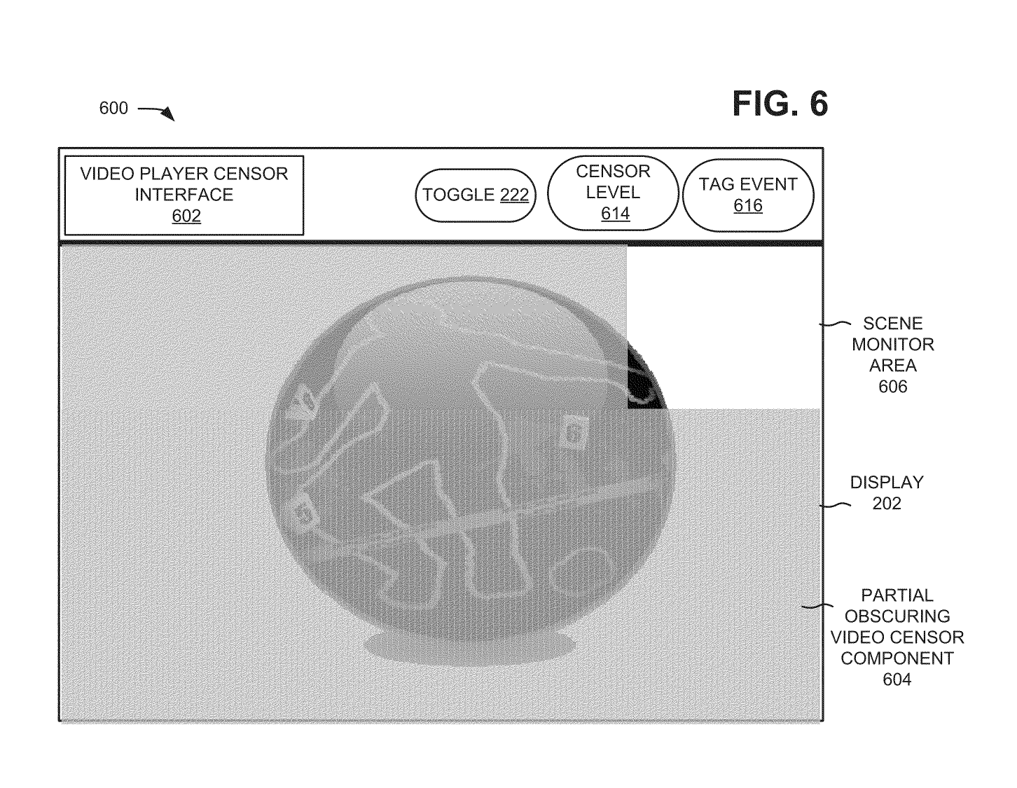

FIG. 6 illustrates an exemplary video interface 600 including video censoring components. Video interface 600 may include a display 202, a video player censor interface icon 602, a partial obscuring video censor component 604, a scene monitor area 606, a video censor toggle 222, a censor level selector 614 and a tag event 616. Video interface 600 may be accessed via user device 170.

As shown in FIG. 6, video content may be received and displayed at display 202. The video content may include objectionable video content. Video player censor interface icon 602 may indicate that the display of the objectionable video content may be managed using video censor control.

Partial obscuring video censor component 604 may be overlaid over the objectionable video content. Partial obscuring video censor component 604 may obscure the objectionable content in a manner that shows enough detail of the objectionable video content for the user to track whether a particular scene is ongoing or whether there is a change in the video content, for example from objectionable content to acceptable content.

Scene monitor area 606 may allow the user to directly monitor an area of the objectionable video content without an overlying partial obscuring video censor component 604. Scene monitor area 606 may be limited in size to prevent persons in the vicinity of the user without prior knowledge from determining what is occurring in the underlying scene (i.e., objectionable video content) while at the same time allowing the user to monitor for scene changes to acceptable video content. In other words, scene monitor area 606 may provide a keyhole effect.

Video censor toggle 222 may provide a capability to apply or remove partial obscuring video censor component 604 in a similar manner as described above with respect to FIG. 2A.

Censor level 614 may allow the user to set a level of video censor (i.e., obscuring of the objectionable video content) that partial obscuring video censor component 604 is to provide. If the user chooses a “high” level, partial obscuring video censor component 604 may block the objectionable video content completely with the exception of scene monitor area 606 so that the user may easily determine that the screen has changed and provide instructions to exit the censor mode. In some implementations, the partial obscuring video censor component 604 applied for “high” level of censoring may totally block the covered area of the objectionable content. A “medium” level may allow the user to view the objectionable content underlying the partial obscuring video censor component 604.

According to one embodiment, censor level 614 may allow the user to select from a plurality of different types of video censoring components to apply to each type of objectionable content. The objectionable content may be identified based on video content censor metadata received from video censor server 150.

Tag event 616 may allow the user to identify video censor events. The user may access a menu of different video censor events (e.g., from a “drop down” box) to tag (occurrences of) objectionable video content with an event type. The video censor event types may identify a type of objectionable content associated with each application of partial obscuring video censor component 604. For example, the video censor event types may identify the objectionable content as nudity, graphic violence, nudity and graphic violence, etc. User device 170 may store video content censor metadata associated with applications of partial obscuring video censor component 604 (video censor events) and report the video content censor metadata to video censor server 150.

According to one embodiment, each event may be tagged by users so the video censor events can be identified prior to the start of the potentially objectionable content and the user can make the decision as to whether or not to enable the censor setting. Prior to the automated event, a user nay receive a notification that identifies a type of video censor event and request input whether to implement video censoring components. For example, user device 170 may receive and display a message that says ‘Mild violence, enable censor setting y/n?’ or ‘Nudity, enable y/n’?

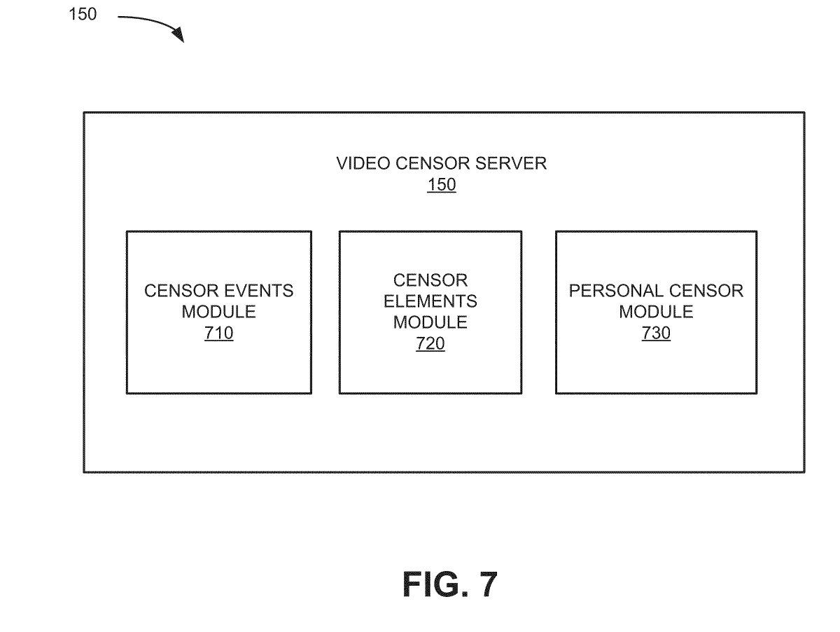

FIG. 7 is a diagram of exemplary functional components of video censor server 150. In one implementation, the functions described in connection with FIG. 7 may be performed by one or more components of device 400 (FIG. 4). As shown in FIG. 7, video censor server 150 may include censor events module 710, a censor elements module 720, and a personal censor module 730.

Censor events module 710 may identify video censor incidents. For example, censor events module 710 may receive video content censor metadata from user devices 170 associated with customers of the service provider. The video content censor metadata may identify instances in each video program at which objectionable content was identified. The identification of the video censor events may include a time, duration, and type of objectionable content associated with the video censor event. Censor events module 710 may aggregate video censor events associated with a same video program from multiple different persons (i.e., crowd sourced identification of video censor events) and determine video content censor metadata to provide via automatic video censor settings. Censor events module 710 may continuously analyze the times in which the video censor events for different users in a same video program overlap and determine start times for video censor events based on this information.

According to one embodiment, censor events module 710 may take the earliest start time for a particular video censor event and subtract a predetermined time (which may represent a reaction time and/or a “cushion” between the start of the video censor event and the application of the video censoring components (e.g., 3 seconds, assuming the start of the scene promoted the event). Censor events module 710 may provide the identification of the video censor event, including the adjusted start time, to user devices 170 that request video content censor metadata. Video censor client device 500 may automatically apply the video censoring components based on the adjusted start time for the video censor events and ensures that the scenes containing objectionable content are fully obscured (e.g., blurred, blocked, etc.). Similarly, censor events module 710 may provide an end time for the video censor event based on adjusting the time that a user removes the video censoring components.

In some implementations, censor events module 710 may receive feedback from user devices 170 if a particular censor event was erroneously applied. For example, a user may send an explicit feedback form that states that the particular video censor event is incorrect or the users (e.g., multiple different users) may consistently remove the video censoring components in a manner (e.g., from a same scene) that suggests that the user does not think that video censoring components were warranted for the particular sequence of video content (e.g., the user may leave video censoring components in place for other scenes but remove for the particular scene). An incorrect video censor event may include a wrong type of objectionable content, an incorrect designation of the video content as objectionable content, etc. According to another example, censor events module 710 may poll the user regarding scenes (i.e., objectionable content) that were missed by the system.

Censor elements module 720 may determine censor elements to be applied to provide video censor in conjunction with particular objectionable video content. For example, Censor elements module 720 may provide a first type of video censoring components to be applied for video censor in conjunction with a first type of objectionable content and a second type of video censoring components to be applied for video censor in conjunction with a second type of objectionable content.

Personal censor module 730 may allow the user to select censor levels and different censor protection elements based on a user profile, network on which the user device is located, live feedback from the user device and/or user. Personal censor module 730 may provide personalized settings in conjunction with demographic and user profile information received from/stored in profile server 130.

According to one implementation, personal censor module 730 may identify different types of objectionable content based on user demographics. Personal censor module 730 may receive a request for video content censor metadata from a requesting user device 170 and identify a requesting user demographic associated with the requesting user device 170 (e.g., based on information received form profile server 130). Personal censor module 730 may provide video content censor metadata identifying at least one of the different types of objectionable content to the requesting user device 170 based on the requesting user demographic.

In some implementations, personal censor module 730 may generate and or provide video content censor metadata to user devices 170 that may enable or enhance implementation of video content censor features. The video content censor metadata may be associated with particular video content on a scene by scene basis (e.g., the video content censor metadata may identify particular objectionable video content) or with the entire video content (e.g., the video content censor metadata may indicate that the video content includes objectionable video content).

FIG. 8 is a flow chart of an exemplary process 800 for implementing video player censor controls according to implementations described herein. In one implementation, process 800 may be performed by video censor client device 500. In another implementation, some or all of process 800 may be performed by another device or group of devices, including or excluding video censor client device 500.

As shown in FIG. 8, video censor client device 500 may provide a video censor interface that includes a video censor toggle (block 802). For example, video censor client device 500 may provide the video censor interface in response to user device 170 accessing a video application. The video censor interface and associated video censor application may be implemented in conjunction with the video application on user device 170. The video censor toggle may include a capability to provide video censoring components based on receipt at the user device 170 of a predetermined input by the user.

At block 804, video censor client device 500 may receive video content, e.g., as a video system, a downloaded film, etc. The user may request a video program from content delivery server 112. Video censor client device 500 may identify the video program.

Video censor client device 500 may receive input identifying objectionable content (block 806). For example, the user may provide input requesting video censoring components. The user may provide the input based on manual identification of objectionable content.

At block 808, video censor client device 500 may provide video censoring components based on the objectionable content. For example, video censor client device 500 may provide video censoring components that obscure or block the objectionable content.

According to one implementation, video censor client device 500 may apply a blurring effect to the objectionable content. Within applications of the blurring effect (or prior to application of the blurring effect), video censor client device 500 may allow the user to implement different settings (e.g., low, medium, and high, indicating increasing levels of video censor) that provide different levels of video censor based on a particular setting. For example, the user may want to choose a “high” setting while in close quarters (e.g., on an airplane as part of an airplane mode for the user device 170), but “low” setting while in a public setting, but not sitting elbow to elbow with other persons.

Video censor client device 500 may report the video censor event to video censor server 150 (block 810). The video censor event may identify the video program, the time at which the video censor event occurred and a type of video censor protecting component that was selected to block or obscure the objectionable content.

According to one implementation, video censor client device 500 may also identify a type of objectionable content (e.g., the user may select a particular type of objectionable content from a menu of different types of objectionable content when applying the video censoring components to the video content). Video censor client device 500 may provide a selectable list of tags that identify a plurality of different types of objectionable content. Video censor client device 500 may receive an indication of at least one of the tags. Video censor client device 500 may associate (e.g., store the type of objectionable content in a database table linked with the video content) the type of video content identified by the tag with the objectionable content.

Video censor client device 500 may receive video content censor metadata associated with a video program received at user device 170 (block 812). For example, video censor client device 500 may send a request for the video content censor metadata included in (or in conjunction with) a request for a video program. Alternatively, the video content censor metadata may be provided automatically with the video program.

At block 814, video censor client device 500 may apply video censoring components based on video content censor metadata. For example, video censor client device 500 may use the video content censor metadata to identify times in the video program at which objectionable content appears and automatically apply the video censoring components to block or obscure the video content.

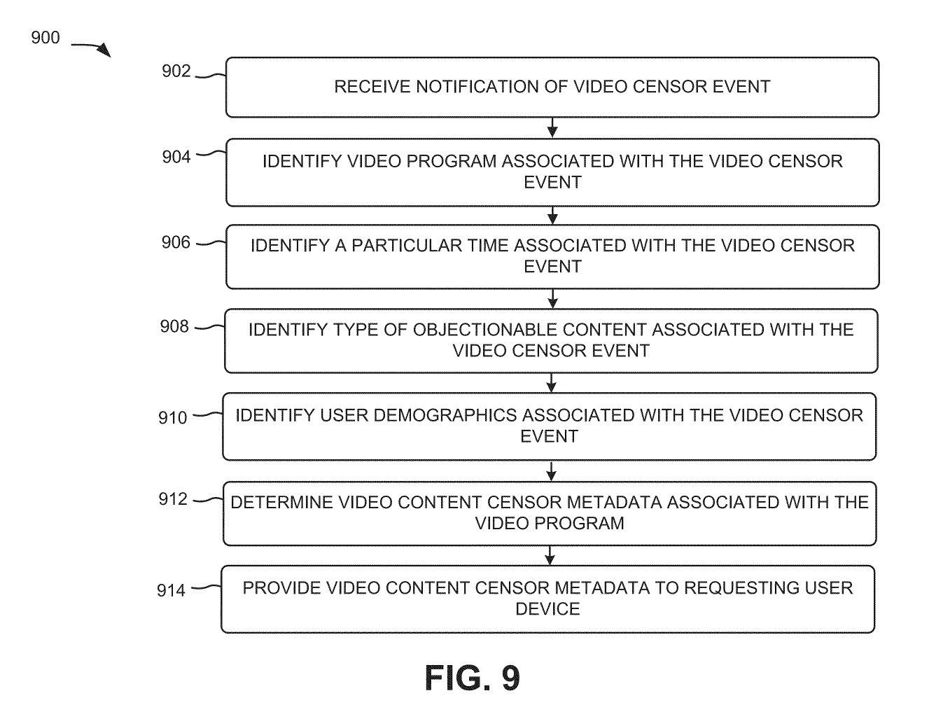

FIG. 9 is a flow chart of an exemplary process 900 for implementing video player censor controls according to implementations described herein. In one implementation, process 900 may be performed by video censor server 150. In another implementation, some or all of process 900 may be performed by another device or group of devices, including or excluding video censor server 150.

As shown in FIG. 9, video censor server 150 may receive a notification of a video censor event from a user device 170 (block 902). For example, video censor server 150 may receive notification of the video censor event when a user provides input requesting video censoring components while watching a video program. User device 170 may send a signal to video censor server 150, for example, via public network 190. In some implementations, user device 170 may send a single notification that includes all video censor events associated with a single video program when the user device 170 completes or pauses receipt of the video program (e.g., the user stops watching a movie).

Video censor server 150 may identify a video program associated with the notification (block 904). For example, video censor server 150 may match metadata associated with the notification with cataloged video programs (e.g., from catalog server 122).

Video censor server 150 may determine a time of the video censor event in the video program (block 906). For example, video censor server 150 may match a time stamp associated with the video censor event to a time at which the video program was provided to the user device 170. Video censor server 150 may determine a beginning time, an end time and a duration of the video censor event.

At block 908, video censor server 150 may determine a type of event associated with the video censor event. For example, video censor server 150 may receive an indication that the objectionable content was a particular type of video content (e.g., nudity, graphic violence) from the user device 170.

Video censor server 150 may identify demographics of a user associated with the video censor event (block 910). For example, video censor server 150 may identify demographics and other user profile information in conjunction with profile server 130.

At block 912, video censor server 150 may determine video content censor metadata for the video program based on the video censor event. For example, video censor server 150 may match the identified time and other information for each censor event identified by the user device 170 with similar information provided by other users. Video censor server 150 may average or perform additional analysis of the video censor events from all users (or a subgroup of users, sorted, e.g., based on demographics or other user profile information) for a video program to determine video content censor metadata for each video program.

According to one implementation, video censor server 150 may analyze the video program to detect scene transitions (or scene changes) and combine this information with video censor event times received from user devices 170 to determine times at which the video censoring components are to be applied to obscure or block objectionable content.

Video censor server 150 may provide video content metadata to requesting user devices 170 in association with the video program (block 914). For example, video censor server 150 may provide the video content censor metadata to a requesting user device 170 to be implemented concurrently with a video program that is currently being received (or played) by the user device 170.

Systems and/or methods described herein may allow for video censor based on application of video censoring components to block or obscure objectionable content. The video censoring components may allow the user to manually determine transitions in the video content from objectionable content to acceptable content while sufficiently disguising or blocking the objectionable content. The systems and methods may provide a personal censor for a user to control content displayed on a user device.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. For example, while series of blocks have been described with respect to FIGS. 8 and 9, the order of the blocks may be modified in other implementations. Further, non-dependent blocks may be performed in parallel.

It will be apparent that different aspects of the description provided above may be implemented in many different forms of machine-readable instructions, firmware, and hardware in the implementations illustrated in the figures. The actual machine-readable instructions or specialized control hardware used to implement these aspects is not limiting of the invention. Thus, the operation and behavior of these aspects were described without reference to the specific machine-readable instructions—it being understood that machine-readable instructions and control hardware can be designed to implement these aspects based on the description herein.

Further, certain portions of the invention may be implemented as a “component” or “system” that performs one or more functions. These components/systems may include hardware, such as a processor, an ASIC, or a FPGA, or a combination of hardware and machine-readable instructions.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

1. A computer-implemented method comprising:
receiving, at a user device, video content;
providing, on an interface of the user device, a video censor toggle that is configured to provide video censoring components based on an input received from a user, wherein the video censoring components are configured to substantially obscure the video content in a manner that a person without previous context of the video content will be unable to determine activities depicted in the video content;
receiving a selection of the video censor toggle from the user at a particular time; and
substantially obscuring the video content using the video censoring components based on a selection of the video censor toggle.

2. The computer-implemented method of claim 1, further comprising:
reporting a video censor event to a video censor server, wherein the video censor event includes an identification of the video content, and the particular time in the video content at which the input was received at the video censor toggle.

3. The computer-implemented method of claim 1, further comprising:
identifying the video content displayed at the particular time as objectionable content based on selection of the video censor toggle; and
identifying the objectionable content as one of nude content or graphic violence content.

4. The computer-implemented method of claim 1, wherein identifying the video content displayed at the particular time further comprises:
providing a selectable list of tags that identify a plurality of different types of objectionable content;
receiving an indication from the user of at least one of the tags; and
associating the type of video content identified by the tag with the video content.

5. The computer-implemented method of claim 1, wherein substantially obscuring the video content using the video censoring components further comprises:
completely blocking a substantial portion of screen of the user device displaying the video content; and
providing a view of the video content in a limited portion of the screen.

6. The computer-implemented method of claim 1, wherein substantially obscuring the video content using the video censoring components further comprises:
blurring the video content.

7. The computer-implemented method of claim 6, wherein blurring the video content further comprises:
blurring the video content based on one of a plurality of levels, wherein the plurality of levels include at least a low level and a high level of substantially obscuring the video content.

8. The computer-implemented method of claim 1, further comprising:
receiving video content censor metadata, wherein the video content censor metadata identifies video censor events in the video content;
automatically providing the video censoring components based on the video content censor metadata.

9. The computer-implemented method of claim 8, further comprising:
determining a percentage of the video content that includes objectionable content based on the video content censor metadata; and
providing a notification of the percentage of the video content that includes objectionable content to the user.

10. The computer-implemented method of claim 8, wherein the video content censor metadata identifies a type of objectionable content and automatically providing the video censoring components further comprises:
identifying a plurality of different types of video censoring components; and
providing at least one of the plurality of different types of video censoring components based on the type of objectionable content.

11. The computer-implemented method of claim 8, further comprising:
providing an option to report the video censor event as erroneous.

12-18. (canceled)

19. A non-transitory computer-readable medium including instructions to be executed by a processor in a user device, the instructions including one or more instructions, when executed by the processor, for causing the processor to:
access video content;
provide, on an interface of the user device, a video censor toggle that is configured to provide video censoring components based on an input received from a user, wherein the video censoring components are configured to substantially obscure the video content in a manner that a person without previous context of the video content will be unable to determine activities in the video content;
receive the input from the user at a particular time;
identify the video content displayed at the particular time as objectionable content based on receiving the input;
substantially obscure the objectionable video content using the video censoring components; and
report a video censor event to a video censor server, wherein the video censor event includes a time in the video content at which the video censoring components.

20. The non-transitory computer-readable medium of claim 19, wherein the processor is configured to:
determine a presence or a proximity of another person to the user device;
provide the video censoring components based on the detected presence or proximity of the other person.

21. A device, comprising:
a memory to store a plurality of instructions; and
a processor configured to execute the instructions in the memory to:
receive video content;
provide, on an interface of the device, a video censor toggle that is configured to provide video censoring components based on an input received from a user, wherein the video censoring components are configured to substantially obscure the video content in a manner that a person without previous context of the video content will be unable to determine activities depicted in the video content;
receive a selection of the video censor toggle from the user at a particular time; and
substantially obscure the video content using the video censoring components based on a selection of the video censor toggle.

22. The device of claim 21, wherein the processor is further to:
report a video censor event to a video censor server, wherein the video censor event includes an identification of the video content, and a time in the video content at which the input was received at the video censor toggle.

23. The device of claim 21, wherein the processor is further to:
identify the video content displayed at the particular time as objectionable content based on selection of the video censor toggle; and
identify the objectionable content as one of nude content or graphic violence content.

24. The video service provider device of claim 21, wherein, when identifying the video content displayed at the particular time, the processor is further to:
provide a selectable list of tags that identify a plurality of different types of objectionable content;
receive an indication from the user of at least one of the tags; and
associate the type of video content identified by the tag with the video content.

25. The video service provider device of claim 21, wherein, when substantially obscuring the video content using the video censoring components, the processor is further to:
completely block a substantial portion of screen of the user device displaying the video content; and
provide a view of the video content in a limited portion of the screen.

26. The video service provider device of claim 21, wherein, when substantially obscuring the video content using the video censoring components, the processor is further to:
blur the video content.

27. The device of claim 21, wherein the processor is further to:
receive video content censor metadata, wherein the video content censor metadata identifies video censor events in the video content;
